(19) United States
(12) Patent Application Publication
(10) Pub. No.: US 2014/0372627 A1
(43) Pub. Date: Dec. 18, 2014

(54) FAULT-TOLERANT WEB CACHING

(71) Applicants: Michael Axelrod, Redwood City, CA (US); Ankur Jain, Mountain View, CA (US)

(72) Inventors: Michael Axelrod, Redwood City, CA (US); Ankur Jain, Mountain View, CA (US)

(73) Assignee: GOOGLE INC., Mountain View, CA (US)

(21) Appl. No.: 13/149,587

(22) Filed: May 31, 2011

(51) Int. Cl. G06F 15/173

(52) U.S. Cl. 709/241

(57) ABSTRACT

Methods, systems, and apparatus, including computer programs encoded on a computer storage medium, for monitoring capability to process web traffic. At various times, a web proxy announces a most specific route that is received by multiple clients configured to send web traffic for an address to a received most specific route to the address. The web proxy processes web traffic received from one of the clients as a result of announcing the route. When the web proxy determines a decrease in processing capability of the web proxy, the web proxy ceases to announce the most specific route such that one or more of the clients direct web traffic for the address to an alternative less specific route.

### BACKGROUND

This specification relates to digital data processing and, in particular, fault-tolerant web caching.

A packet-switched network, such as the Internet, can be used to connect content servers that host content such as web pages, and clients (for example, computer systems) that users use to access the content. In particular, the content servers and the clients can communicate through proxy servers (also known as web proxies or web caches) that act as intermediaries for requests from the clients seeking content from the content servers. In a typical situation, a client, which is connected to the Internet, transmits a request for content to the web proxy. The web proxy receives content from a content server (or from the web proxy's cache) that can satisfy the client's request, and transmits the content to the client in response to the request.

### SUMMARY

This specification describes technologies relating to monitoring capability to process web traffic.

In general, one innovative aspect of the subject matter described here can be implemented by data processing apparatus as a method. At various times, a web proxy announces a first route in which the first route is more specific than a second route for another web proxy. Both the first route and the second route are received by multiple clients. The multiple clients are configured to send web traffic for an address to a received most specific route to the address. The web proxy processes web traffic received from one or more of the multiple clients as a result of announcing the first route. The web proxy determines a decrease in processing capability of the web proxy. Responsive to the determining, the web proxy ceases announcement of the first route such that one or more of the multiple clients direct web traffic for the address to the second route.

These, and other aspects, can include one or more of the following features. Determining the decrease in the processing capability of the web proxy can include determining an ability of the web proxy to provide content. Determining the ability can further include assessing a health of a network protocol stack which is used to provide the content. Determining the decrease in the processing capability of the web proxy can further include determining performance metrics of the web proxy that represent a reachability of the web proxy to the other web proxy or one or more of the multiple clients or a combination of the other web proxy and the one or more of the multiple clients, to determine the ability of the web proxy to provide content. A client of the one or more of the multiple clients can be an end-user data processing apparatus. The first route and the second route can be announced using border gateway protocol. The address can be an Internet Protocol Address. The web proxy can determine an increase in the capability of the web proxy, and responsive to the determining, resume announcement of the first route such that the one or more of the clients direct web traffic for the address to the first route. It can be determined that the web proxy is in closer geographic proximity to the one or more of the plurality of clients relative to the other web proxy, and responsive to the determining, the first route can be announced.

Another innovative aspect of the subject matter described here can be implemented as a computer-readable medium storing computer software instructions executable by data processing apparatus to perform the methods described here. Yet another innovative aspect of the subject matter described here can be implemented as a data processing apparatus, and a computer-readable medium storing computer software instructions executable by the data processing apparatus to perform the methods described here.

Particular implementations of the subject matter described in this specification can be implemented so as to realize one or more of the following advantages. The methods described here combine abilities of a web proxy to monitor its own health and to process requests for web traffic. By configuring a web proxy to stop announcing its availability to serve requests to process web traffic, alternative web proxies that can provide service can be quickly identified. This can decrease a duration during which a client experiences an unavailability of service when a web proxy fails. Also, a delay introduced by implementing an external monitoring and control system responsible for failure detection and mitigation, can be decreased and likely eliminated. Systems that implement the techniques described here can be simple and cost-efficient.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example system configured to provide content to clients through web proxies.

FIG. 2 is a schematic of example communications between clients and proxies to receive and provide content, respectively.

FIG. 3 is a flowchart of an example process for determining an ability of a web proxy to provide content.

FIG. 4 is a flow chart of an example process for monitoring a capability to provide web traffic.

Like reference numbers and designations in the various drawings indicate like elements.

### DETAILED DESCRIPTION

A web proxy can be implemented, for example, as one or more servers (for example, data processing apparatus), each of which is configured to receive requests for content from clients and to establish communication between content servers that can satisfy the requests, and the clients. A web proxy can also be configured to cache content, for example, to store content locally on the one or more servers. Thus, in some situations, a web proxy that caches content may satisfy a client request faster than web proxy that retrieves content from a content server.

A web proxy is capable of communicating with one or more content servers and also caching content received from the content servers. In some implementations, a load balancing system distributes the task of providing web traffic from clients across multiple web proxies, thereby avoiding bottlenecks at any web proxy. In further implementations, each web proxy can be placed at a geographic location in the network such that a request from a client is directed to and satisfied by a web proxy that is closer geographically to the client than other web proxies.

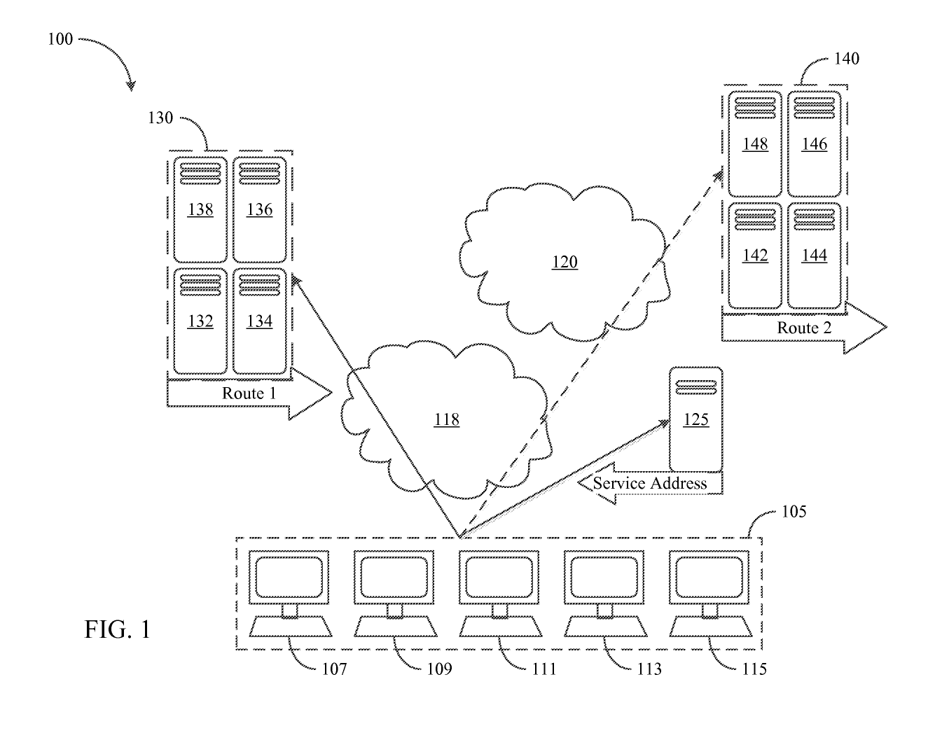

FIG. 1 is an example system 100 to provide content to clients 105 (for example, clients 107, 109, 111, 113, 115) through web proxies. A client (for example, client 107) is a computer system that is connected to a network, such as the Internet, or to another network. A computer system is an end-user data processing apparatus, such as a desktop computer, a laptop computer, a personal digital assistant, a smart phone, a tablet computer, and the like. Users can access the Internet using the computer systems. The system 100 further includes one or more network service providers (for example, provider 118 or provider 120) that provide network access to the clients 105.

The system 100 includes one or more web proxies (for example, web proxy 130 and web proxy 140). Each of the web proxies is configured to respond to hypertext transfer protocol (HTTP) requests (or requests of a different protocol) for content from a client by obtaining the requested content from a content server or from a cache of content that was previously received from a content server, and to send the obtained content to the requesting client in a response message. An example of content server is a web server. Other content servers are possible. Each web proxy announces, at various times, a route that is received by the clients 105 and through which the clients 105 are configured to send requests.

Using techniques described with reference to the following figures, a web proxy in the system 100 is configured to self-monitor its capability to continue to process web traffic. For example, if a web proxy 130 in the system 100 determines a decrease in its own web-traffic processing capability to a level that is insufficient to satisfy requests from the clients 105, then the web proxy 130 withdraws itself from the network traffic by ceasing to announce the route through which the web proxy is configured to receive web traffic.

When the web proxy 130 self-withdraws, the clients 105 send traffic to a less specific route announced by another web proxy, for example, web proxy 140. Whereas the web proxy 130 and the other web proxy 140 both announced respective routes, the clients 105 sent web traffic to the route announced by the web proxy 130 rather than the web proxy 140, for example, because the former was in greater geographical proximity to the clients 105 compared to the latter. Because the other web proxy 140 continued to announce its route after the web proxy 130 self-withdrew, the clients 105 will send the clients 105 web traffic to the route announced by the other web proxy 140. Consequently, the clients 105 do not experience service unavailability. The system can include multiple web proxies in addition to the web proxy 130 that announces the most specific route and the web proxy 140 that announces a less specific route. As the most specific route ceases to be announced, web traffic can be routed to less specific routes announced by one of the multiple web proxies in the system.

The web proxy 130 that has self-withdrawn continues to monitor its own processing capability. When the web proxy 130 determines that its processing capability has returned to a level that is sufficient to satisfy requests from the clients 105, the web proxy 130 injects itself into the network and resumes processing web traffic. To do so, the web proxy 130 resumes announcing the route through which the clients 105 can send it traffic. The clients 105 determine that the route announced by the web proxy 130 is more specific than the route through which the web proxy 140 processes web traffic, and send the traffic through the route announced by the web proxy 130. In this manner, the web proxy 130 is configured to monitor its own health and, depending on the outcome of the monitoring, either withdraw itself from or inject itself into the network traffic to provide content to the clients 105. If the web proxy 130 crashes, then announcements from the web proxy 130 cease, and hence traffic is sent to the route announced by the web proxy 140.

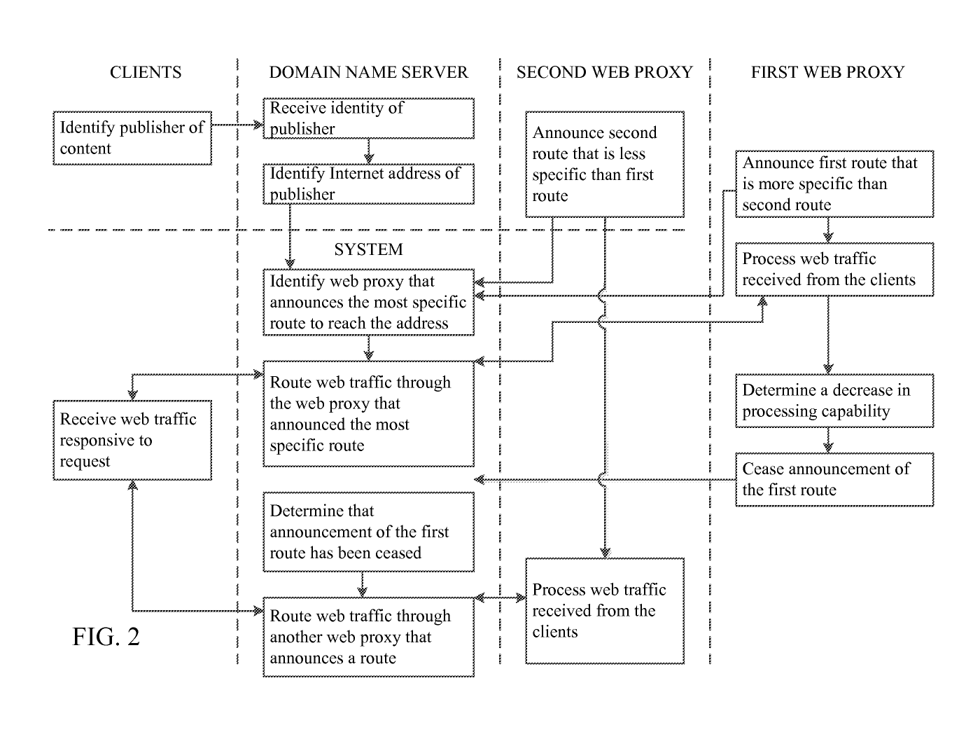

The system 100 includes a domain name server (DNS) 125 between the web proxies 130, 140, and the clients 105. As described with reference to FIG. 2, the clients 105 identify a source of content using a human-recognizable address that uniquely represents the source. The DNS 125 receives the address and identifies a machine-recognizable, Internet address representing an entity (for example, content server, caching web proxy) that hosts the content of the source that the clients 105 have identified. The system 100 then selects the web proxy that announces a most suitable route to transmit through which the clients 105 can route the request for content to the entity represented by the Internet address, and to transmit the content retrieved from the entity in response to the request, to the clients 105.

FIG. 2 is a schematic of example communications between clients and proxies to receive and provide content, respectively. Clients, for example, clients 107, 109, 111, 113, 115, identify a source of content, for example, a publisher's Internet website. For example, a user of a computer system enters a Uniform Resource Locator (URL) of the website hosted by a content server within a web browser. The network service provider (for example, service provider 118 or 120) transmits the URL to the DNS 125. The DNS 125 is configured to map human-recognizable URLs to machine-recognizable service Internet Protocol (IP) addresses that each represents a content server that hosts a resource addressed by a URL. The DNS 125 identifies the service IP address of the publisher from whom the user requests content. The Internet address can identify the content server that hosts the resource (i.e., the content) that the user has requested or a caching web proxy that stores a copy of the resource. For example, the DNS 125 identifies the service address, x.y.z.10, and provides the address to the system 100.

The system 100 then identifies a web proxy that can route the request for web traffic from the clients 105 to the content server (or caching web proxy) represented by that the DNS 125 has identified. The first web proxy and the second web proxy, each announces, at various times, a respective route that is received by the client through which the proxy is configured to send web traffic to an address. For example, the first web proxy and the second web proxy announce a first route and a second route, respectively, by implementing a Border Gateway Protocol.

In some situations, the first web proxy is in greater geographical proximity to the clients 105 than the second web proxy, and is consequently, better suited to route the request for web traffic to the service address than the second web proxy. The first web proxy uses the most specific IP subnet to announce the route. In some implementations, the first web proxy uses a 24-bit prefix to announce the route, for example, x.y.z.0/24. Because the first web proxy is announcing the most specific route, the system 100 routes web traffic through the first web proxy. The clients 105 receive web traffic from the content server (or caching web proxy) responsive to the request through the route that the first web proxy announces.

As discussed previously, the first web proxy self-monitors its own processing capability, i.e., an ability of the first web proxy to continue to process web traffic and to route content. To do so, the first web proxy can assess a health of a network protocol stack implemented in each server in the first web proxy. Alternatively, or in addition, the first web proxy can determine performance metrics that represent an ability of the web proxy to reach the second web proxy, other web proxies in the system, one or more of the clients, one or more of the content servers to which the first web proxy is connected, or all of them.

Based on either the health of the network protocol stack or the performance metrics or both, the first web proxy can determine a decrease in its own processing capability. The first web proxy can consequently cease announcement of the first route. Because the first route is no longer announced, the clients 105 can no longer send web traffic to the content server (or caching web proxy) through that route.

The second route is an alternative route to the same content server (or caching web proxy). However, the second route is less specific relative to the first route because, for example, the second web proxy has less geographical proximity to the client relative to the first web proxy. Thus, the second route is a cover route having, for example, a 10-bit prefix—x.y.z.0/10. The clients 105 prefer to send web traffic through the more specific route over the less specific one. But, when the more specific route disappears, for reasons discussed above, then the system 100 converges to use the less specific route to process web traffic and the clients 105 send web traffic to the less specific route. Consequently, the system 100 decreases or eliminates the possibility of service brownout.

In some situations, monitoring software daemons can be implemented on the first web proxy to continue to monitor the processing capability of the first web proxy, for example, by monitoring a health of the network protocol stack or the performance metrics or both. Based on the monitoring, if the first web proxy determines that its processing capability has increased to a level that is sufficient to process web traffic, the first web proxy resumes announcing the first route, i.e., the route having the 24-bit prefix. Because the first route is more specific than the second route, the system 100 converges to use the more specific route.

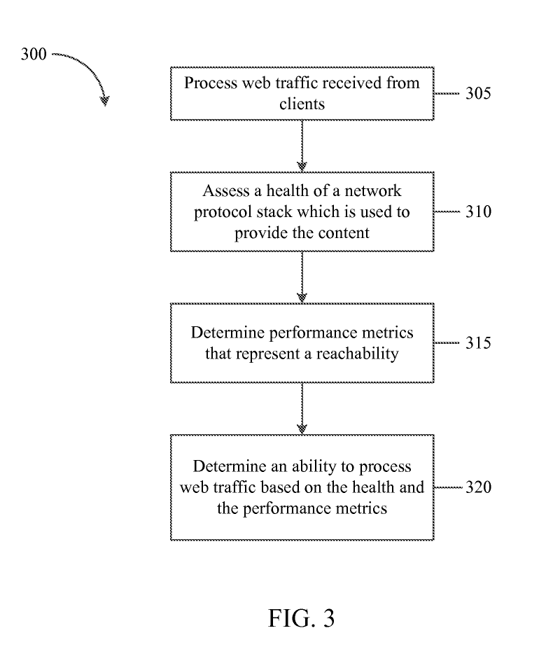

FIG. 3 is a flowchart of an example process 300 for determining an ability of a web proxy to provide content. The process 300 can be implemented by one or more computer systems that each includes data processing apparatus configured to execute software instructions stored on a computer-readable medium. For example, the one or more computers collectively form a web proxy. The process 300 processes web traffic received from clients (step 305). For example, the web proxy announces a primary route that is received by clients and that is more specific than other routes that other web proxies announce. Requests for web traffic from client are routed through the primary route to destinations identified by service IP addresses.

The process 300 assesses a health of a network protocol stack which is used to provide the content (step 310). The process 300 determines performance metrics that represent a reachability (step 315). In some implementations, the web proxy implements monitoring daemons that are executable by the one or more computer systems that form the web proxy to determine the health of the network protocol stack and performance metrics. For example, the monitoring software daemons are configured to determine connections between the web proxy and other servers (content servers or web proxies or both) to which the web proxy is connected. The daemons are configured to determine whether requests to a server, that the web proxy forwards, reached the server. The daemons also identify packet losses, increases in latency of the paths to reach a server, or both. The daemons can determine an increase in memory usage, high rate of turning of the disks on the web proxy servers, and similar signals to assess the health of the web proxy and to determine its performance metrics.

The process 300 determines an ability to process web traffic based on the health and the performance metrics (step 320). For example, upon self-monitoring, if the web proxy determines that its ability to process web traffic has decreased to an unsatisfactory level, then the web proxy withdraws itself from the network traffic by ceasing to announce its route. Subsequently, if the web proxy determines that its ability has increased to a satisfactory level, then the web proxy resumes announcing its route. Because the route that the web proxy announces is the most specific route, web traffic will resume processing client's traffic.

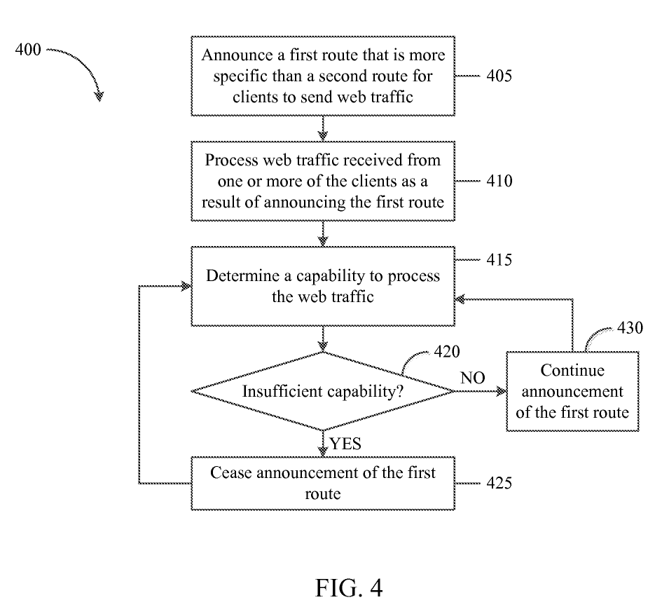

FIG. 4 is a flow chart of an example process 400 for monitoring a capability to provide web traffic. The process 400 can be implemented by data processing apparatus executing computer software instructions stored on a computer-readable medium. The process 400 announces a first route that is more specific than a second route to clients to send web traffic (step 405). The process 400 processes web traffic received from one or more of the clients as a result of announcing the first route (step 410). The process determines a capability to process the web traffic (step 415). The process 400 checks if the capability is insufficient (step 420). If yes (decision branch “YES”), then the process 400 ceases announcement of the first route (step 425). If no (decision branch “NO”), then the process 400 continues announcement of the first route (step 430). The process 400 continues to determine a capability to process the web traffic (step 415).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, for example, a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example, multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, for example, an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device (for example, a universal serial bus (USB) flash drive), to name just a few. Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of digital data communication, for example, a communication network. Examples of communication networks include a local area network (“LAN”) and a wide area network (“WAN”), an inter-network (for example, the Internet), and peer-to-peer networks (for example, ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (for example, an HTML page) to a client device (for example, for purposes of displaying data to and receiving user input from a user interacting with the client device). Data generated at the client device (for example, a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some implementations, the system 100 can include multiple web proxies, for example, eight web proxies load balanced to supply 255 service IP addresses. The system 100 can implement a load balancing layer between the multiple web proxies. The content requested by a user can be cached by a web proxy. So, the service IP address identified by the DNS 125 can be the address of one and all of the eight caching web proxies (known as any-cast). The route announced by the caching web proxy can point to eight servers simultaneously. Because other web proxies in the system can either cache the content or establish a connection to a content server that hosts the content, then, if any one out of the eight caching web proxies fails, the system can converge to one of the remaining seven web proxies, as long as at least one of them is capable of serving user requests. Once the system determines that user requests can no longer be processed or all web caches have failed, the system can cease announcing the route, and can converge on the least specific route announced by a secondary cluster of web proxies.

What is claimed is:

1. A method comprising:
announcing, by a first web proxy hosted on a first server, a first route, wherein the first web proxy is configured to receive, from one or more clients, through the first route, requests for content hosted on a particular content server, the first web proxy caching some of the content hosted on the particular content server;
announcing, by a different, second web proxy hosted on a second server, a different, second route, wherein the second web proxy is configured to receive, from the one or more clients, through the second route, requests for content hosted on the same particular content server, the second web proxy caching some of the content hosted on the particular content server;
determining that the first route is more specific than the second route and, as a result of the determining, routing the requests for content hosted on the particular content server to the first web proxy for processing;
processing, by the first web proxy, the requests that are routed to the first web proxy, including obtaining respective content that satisfies each of the requests and providing the respective content in response to each corresponding request;
monitoring, by the first web proxy, a processing capability of the first web proxy; and
upon determining, based on the monitoring, that the processing capability of the first web proxy is insufficient to process the requests that are routed to the first web proxy, ceasing, by the first web proxy, the announcing of the first route.

2. The method of claim 1, wherein monitoring the processing capability of the first web proxy includes determining an ability of the first web proxy to provide the respective content in response to each corresponding request.

3. The method of claim 1, wherein monitoring the processing capability of the first web proxy includes assessing a health of a network protocol stack which is used to provide content that satisfies the requests.

4. The method of claim 1, wherein monitoring the processing capability of the first web proxy includes determining performance metrics of the first web proxy that represent an ability of the first web proxy to reach the particular content server.

5. (canceled)

6. (canceled)

7. (canceled)

8. The method of claim 1, further comprising:
upon determining, based on the monitoring, that the processing capability of the first web proxy has improved by a sufficient amount, resuming announcing, by the first web proxy server, of the first route.

9. The method of claim 1, further comprising:
determining that the first web proxy is in closer geographic proximity to the one or more of the plurality of clients relative to the second web proxy; and
responsive to determining that the first web proxy is in closer geographic proximity, determining that the first route is more specific than the second route.

10. A non-transitory computer-readable medium storing computer software instructions executable by data processing apparatus to perform operations comprising:
announcing, by a first web proxy hosted on a first server, a first route, wherein the first web proxy is configured to receive, from one or more clients, through the first route, requests for content hosted on a particular content server, the first web proxy caching some of the content hosted on the particular content server;
announcing, by a different, second web proxy hosted on a second server, a different, second route, wherein the second web proxy is configured to receive, from the one or more clients, through the second route, requests for content hosted on the same particular content server, the second web proxy caching some of the content hosted on the particular content server;
determining that the first route is more specific than the second route and, as a result of the determining, routing the requests for content hosted on the particular content server to the first web proxy for processing;
processing, by the first web proxy, the requests that are routed to the first web proxy, including obtaining respective content that satisfies each of the requests and providing the respective content in response to each corresponding request;
monitoring, by the first web proxy, a processing capability of the first web proxy; and
upon determining, based on the monitoring, that the processing capability of the first web proxy is insufficient to process the requests that are routed to the first web proxy, ceasing, by the first web proxy, the announcing of the first route.

11. The medium of claim 10, wherein monitoring the processing capability of the first web proxy includes determining an ability of the first web proxy to provide the respective content in response to each corresponding request.

12. The medium of claim 10, wherein monitoring the processing capability of the first web proxy includes assessing a health of a network protocol stack which is used to provide content that satisfies the requests.

13. The medium of claim 10, wherein monitoring the processing capability of the first web proxy further comprises determining performance metrics of the first web proxy that represent an ability of the first web proxy to reach the particular content server.

14. (canceled)

15. (canceled)

16. (canceled)

17. The medium of claim 10, further comprising:
upon determining, based on the monitoring, that the processing capability of the first web proxy has improved by a sufficient amount, resuming announcing, by the first web proxy server, of the first route.

18. The medium of claim 10, further comprising:
determining that the first web proxy is in closer geographic proximity to the one or more of the plurality of clients relative to the second web proxy; and
responsive to determining that the first web proxy is in closer geographic proximity, determining that the first route is more specific than the second route.

19. A system comprising:
data processing apparatus; and
one or more storage devices storing computer software instructions executable by the data processing apparatus to perform operations comprising:
announcing, by a first web proxy hosted on a first server, a first route, wherein the first web proxy is configured to receive, from one or more clients, through the first route, requests for content hosted on a particular content server, the first web proxy caching some of the content hosted on the particular content server;
announcing, by a different, second web proxy hosted on a second server, a different, second route, wherein the second web proxy is configured to receive, from the one or more clients, through the second route, requests for content hosted on the same particular content server, the second web proxy caching some of the content hosted on the particular content server;
determining that the first route is more specific than a second route and, as a result of the determining, routing the requests for content hosted on the particular content server to the first web proxy for processing;
processing, by the first web proxy, the requests that are routed to the first web proxy, including obtaining respective content that satisfies each of the requests and providing the respective content in response to each corresponding request;
monitoring, by the first web proxy, a processing capability of the first web proxy; and
upon determining, based on the monitoring, that the processing capability of the first web proxy is insufficient to process the requests that are routed to the first web proxy, ceasing, by the first web proxy, the announcing of the first route.

20. The system of claim 19, wherein monitoring the processing capability of the first web proxy includes determining an ability of the first web proxy to provide the respective content in response to each corresponding request.

21. The system of claim 19, wherein monitoring the processing capability of the first web proxy includes assessing a health of a network protocol stack which is used to provide content that satisfies the requests.

22. The system of claim 19, wherein monitoring the processing capability of the first web proxy includes determining performance metrics of the first web proxy that represent an ability of the first web proxy to reach the particular content server.

23. (canceled)

24. (canceled)

25. (canceled)

26. The system of claim 19, further comprising:
upon determining, based on the monitoring, that the processing capability of the first web proxy has improved by a sufficient amount, resuming announcing, by the first web proxy server, of the first route.

27. The system of claim 19, further comprising:
determining that the first web proxy is in closer geographic proximity to the one or more of the plurality of clients relative to the second web proxy; and
responsive to determining that the first web proxy is in closer geographic proximity, determining that the first route is more specific than the second route.

28. The method of claim 1, further comprising:
determining that the first web proxy is no longer announcing the first route;
terminating the routing of requests for content hosted on the particular content server to the first web proxy for processing;
determining that the second route is more specific than any other route that has been announced; and
routing requests, received from the one or more clients, for content hosted on the particular content server, to the second web proxy for processing.

29. The medium of claim 10, further comprising:
determining that the first web proxy is no longer announcing the first route;
terminating the routing of requests for content hosted on the particular content server to the first web proxy for processing;
determining that the second route is more specific than any other route that has been announced; and
routing requests, received from the one or more clients, for content hosted on the particular content server, to the second web proxy for processing.

30. The system of claim 19, further comprising:
determining that the first web proxy is no longer announcing the first route;
terminating the routing of requests for content hosted on the particular content server to the first web proxy for processing;
determining that the second route is more specific than any other route that has been announced; and
routing requests, received from the one or more clients, for content hosted on the particular content server, to the second web proxy for processing.

31. The method of claim 1, wherein determining that the first route is more specific that the second route includes determining that the first route has a network prefix that is longer than a network prefix of the second route.

32. The medium of claim 10, wherein determining that the first route is more specific than the second route includes determining that the first route has a network prefix that is longer than a network prefix of the second route.

33. The system of claim 19, wherein determining that the first route is more specific than the second route includes determining that the first route has a network prefix that is longer than a network prefix of the second route.
